(19) United States
(12) Patent Application Publication
(10) Pub. No.: US 2008/0131252 A1
(43) Pub. Date: Jun. 5, 2008

(54) ELECTRONIC LEVEL INDICATOR FOR A LOADER BUCKET

(76) Inventors: Glenn O. Scheer, Durango, IA (US); Bruce A. Musmaker, Asbury, IA (US)

Correspondence Address: TAYLOR & AUST, P.C., P.O. Box 560, 142. S Main Street, Avilla, IN, 46710, US

(21) Appl. No.: 11/564,997

(22) Filed: Nov. 30, 2006

(51) Int. Cl. G01C 9/06; G06G 7/62

(52) U.S. Cl. 414/698; 701/50

(57) ABSTRACT

A work machine includes a machine frame, a loader and an electronic level indicator. The loader includes a loader frame coupled with the machine frame, a pair of booms pivotally carried by the loader frame, and a bucket pivotally carried at a forward end of the booms. An electronic level indicator includes a first indicator providing an indication of a relative angular orientation between the loader frame and at least one boom. A second indicator provides an indication of a relative angular orientation between the bucket and at least one boom. A controller is coupled with the first indicator, the second indicator and a visual indicator. The controller receives an input signal from each of the first indicator and the second indicator and actuates the visual indicator to indicate when the bucket is level.

### FIELD OF THE INVENTION

The present invention relates to work machines having a front end loader, and, more particularly, to a level indicator for a material bucket of the loader.

Work machines may be used in the agricultural, forestry and construction industries. Examples of work machines include tractors and combines in the agricultural sector, tree harvesters in the forestry sector, and skid loaders and backhoes in the construction sector. Tractors, skid loaders, backhoes, etc. may include a front end loader which is bolted to the machine frame (typically to the frame rails beneath the engine and the rear axle, in the case of a tractor), and driven by auxiliary hydraulics using a joystick or other type lever. Various attachments such as a bucket, pallet forks, hay forks, etc. can be attached and used with the loader frame.

When using a front end loader with a bucket attachment, it may be desirable to scoop material into the bucket by driving forward with the bucket at the level of the material to be scooped. The booms of the loader typically have positive down pressure so that the bucket can be forced against the ground while driving forward. Depending upon the degree of digging required, the bucket is oriented such that the bottom surface of the bucket is level or slightly tipped down. The term “level”, as used herein, is intended to mean that the bottom surface of the bucket is generally parallel to the ground surface over which the work machine is traversing. Thus, even if the work machine is traveling over sloped ground, the bucket is still considered to be “level” when oriented parallel to the ground rather than parallel to horizontal.

Front end loaders may include a mechanical indicator to provide a visual indication to an operator that a bucket is level. In one example, a rod which is pivotally attached at one end with the rear wall of the bucket slides within a tube carried by a boom of the loader. The end of the rod is painted a different color so that the user knows the bucket is level when the rod is positioned such that the transition between the two colors is at the top of the tube. This is a simple and reliable visual indication that the bucket is in a level orientation.

A problem with a mechanical level indicator as described above is that it is not easy to tell to what degree the bucket is tipped when not in the level orientation. Typically, the bucket has a shorter top wall which is generally parallel to the bottom surface of the bucket. It is common for an operator to observe the top wall of the bucket to indirectly determine the orientation of the bottom wall of the bucket. However, depending upon various factors such as the width of the bucket, loader frame configuration, etc., it may not be easy to view the top wall of the bucket.

What is needed in the art is a level indicator for a bucket which is simple to use, reliable and does not add substantially to the complexity or cost of the loader.

### SUMMARY OF THE INVENTION

The invention in one form is directed to a work machine including a machine frame, a loader and an electronic level indicator. The loader includes a loader frame coupled with the machine frame, a pair of booms pivotally carried by the loader frame, and a bucket pivotally carried at a forward end of the booms. An electronic level indicator includes a first indicator providing an indication of a relative angular orientation between the loader frame and at least one boom. A second indicator provides an indication of a relative angular orientation between the bucket and at least one boom. A controller is coupled with the first indicator, the second indicator and a visual indicator. The controller receives an input signal from each of the first indicator and the second indicator and actuates the visual indicator to indicate when the bucket is level.

The invention in another form is directed to a level indicator for a material bucket on a work machine. The level indicator includes a first indicator providing an indication of a relative angular orientation between a loader frame and at least one boom; a second indicator providing an indication of a relative angular orientation between a bucket and at least one boom; a visual indicator; and a controller. The controller is coupled with each of the first indicator, the second indicator and the visual indicator. The controller receives an input signal from each of the first indicator and the second indicator and actuates the visual indicator to indicate when the bucket is level.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a side view of a work machine including an embodiment of an electronic level indicator of the present invention; and

FIG. 2 is a schematic illustration of the work machine and electronic level indicator of FIG. 1.

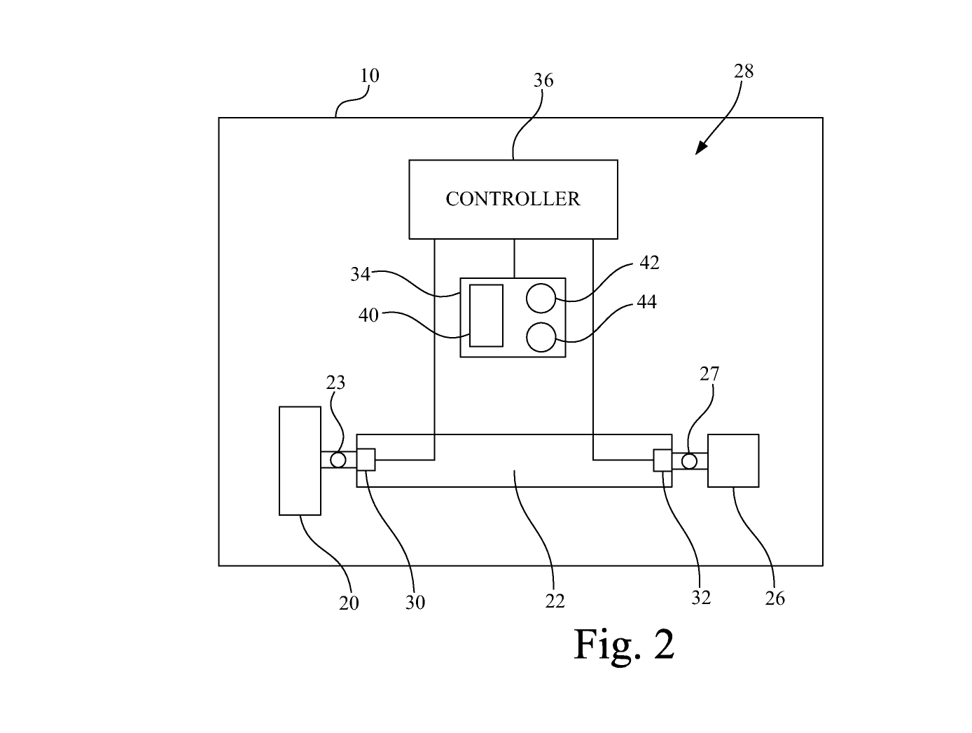

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE PREFERRED EMBODIMENT

Referring now to the drawings, there is shown a work vehicle 10 in the form of a tractor having a front end loader 12. Work machine 10 can also be differently configured, such as a backhoe having a front end loader at the front and a backhoe attachment at the rear of the machine.

Tractor 10 includes a machine frame 14, which in turn carries an internal combustion engine, such as a diesel or gas engine, housed within a hood 16 defining an engine compartment 18 surrounding the engine.

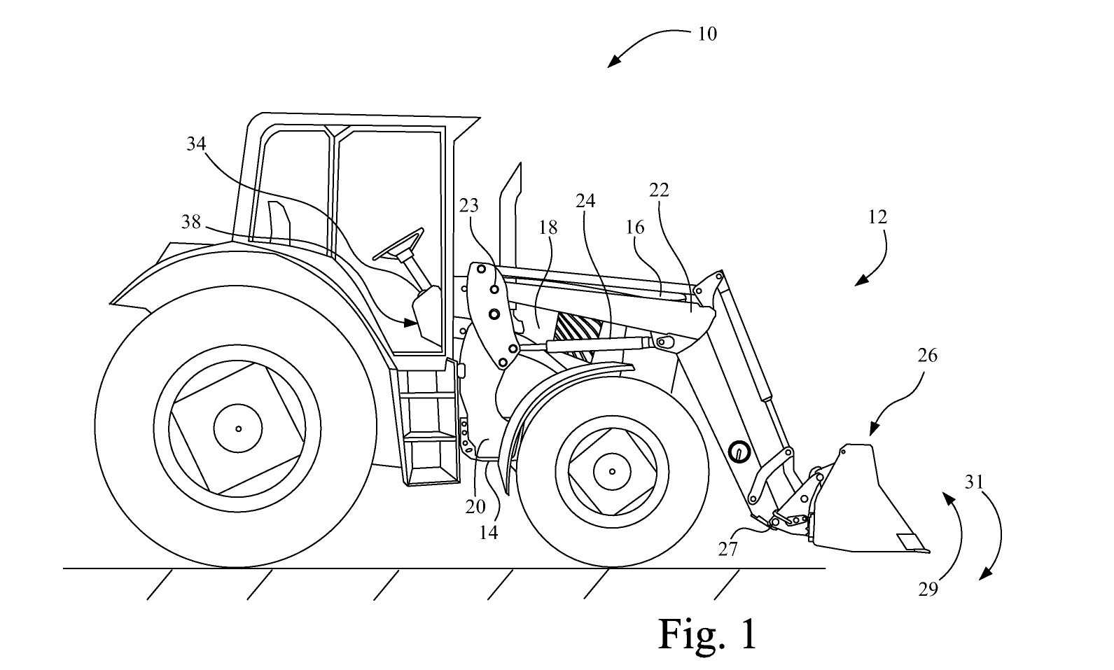

Frame 14 further carries loader 12, including a loader frame 20 extending upward on either side of engine compartment 18, a pair of booms 22 pivotally coupled with loader frame 20 on either side of engine compartment 18, and a pair of lift cylinders 24 interconnecting loader frame 20 with a respective boom 22 (it will be appreciated that in the side view of FIG. 1, only a single boom 22 and lift cylinder 24 are visible). Each boom 22 is pivotally coupled with loader frame 20 with a respective pivot pin 23, and bucket 26 is pivotally coupled with each boom 22 with a pair of pivot pins 27. The bottom end of loader frame 20 can be configured as a single piece which is non-detachable from machine frame 14, or may be configured as a multiple piece loader frame if configured as a detachable front end loader.

A material bucket 26 is attached to the outboard or forward end of loader 12. If configured as a detachable bucket, a different type of loader attachment (not shown), such as pallet forks or hay forks, may also be attached to the outboard or forward end of loader 12.

As indicated above, when using a front end loader with a bucket attachment, it may be desirable to scoop material into the bucket by driving forward with the bucket at the level of the material to be scooped. Depending upon the degree of digging required, the bucket is oriented such that the bottom surface of the bucket is level or slightly tipped down. To that end, and according to an aspect of the present invention, an electronic level indicator 28 is used to provide an operator with a visual indication of whether bucket 26 is level, tipped up (arrow 29 in FIG. 1) or tipped down (arrow 31 in FIG. 1) with respect to the surface over which tractor 10 traverses.

Level indicator 28 includes a first indicator 30, second indicator 32, visual indicator 34 and controller 36. First indicator 30 is preferably configured as a sensor coupled between loader frame 14 and a corresponding boom 22, and provides an output signal corresponding to the angular orientation between loader frame 14 and boom 22. Similarly, second indicator 32 is preferably in the form of a sensor coupled between bucket 26 and a corresponding boom 22, and provides an output signal corresponding to the angular orientation between bucket 26 and boom 22.

First indicator 30 and second indicator 32 provide output signals corresponding to the current geometrical relationship between machine frame 14, loader frame 20, booms 22 and bucket 26. The geometries of these components can be used to determine the angular position of bucket 26. If bucket 26 is tipped up or down and booms 22 are held at a steady angular orientation, then the angular orientation of bucket 26 can be easily recalculated. If booms 22 are also moved up or down, then the angular orientation of bucket 26 can be easily recalculated real time using a periodic sampling.

Controller 36 preferably is part of an electronic control module (ECM) already located onboard work machine 10. Controller 36 can also be a stand-alone controller in addition to the onboard ECM, depending upon the application.

Visual indicator 34 is preferably located on an operator console 38 and includes an on-off switch 40, top light 42 and vertically arranged bottom light 44. Top light 42 is repetitively energized by itself when bucket 26 is tipped up, bottom light 44 is repetitively energized by itself when bucket 26 is tipped down, and top light 42 and bottom light 44 are continuously energized together when bucket 26 is level. More particularly, when bucket 26 is tipped up, top light 42 is repetitively energized with a frequency corresponding to a degree to which bucket 26 is tipped up. Assuming bucket 26 is tipped up from level, top light 42 is energized with a higher frequency as bucket 26 is tipped down approaching level, and is energized with a lower frequency as bucket 26 is tipped up further from level. Similarly, when bucket 26 is tipped down, bottom light 44 is repetitively energized with a frequency corresponding to a degree to which bucket 26 is tipped down. Assuming bucket 26 is tipped down from level, top light 42 is energized with a higher frequency as bucket 26 is tipped up approaching level, and is energized with a lower frequency as bucket 26 is tipped down further from level. In one embodiment, the frequencies of operation of top light 42 and bottom light 44 are as set forth in the table below.

| | | Upper | Lower |
|---|---|---|---|
| | | Indicator | Indicator |
| Bucket | | Light | Light |
| Angle from | | (On/Off or | (On/Off or |
| Level | | Flash Rate | Flash Rate |
| (degrees) | | Hz) | Hz) |
| | 10 or more | 0.4 | OFF |
| | 9 to 10 | 0.5 | OFF |
| | 8 to 9 | 0.6 | OFF |
| | 7 to 8 | 0.7 | OFF |
| | 6 to 7 | 0.8 | OFF |
| | 5 to 6 | 0.9 | OFF |
| | 4 to 5 | 1 | OFF |
| | 4 to 4 | 2 | OFF |
| | 2 to 3 | 3 | OFF |
| | 1 to 2 | 4 | ON |
| | −1 to +1 | ON | ON |
| | −2 to −1 | ON | 4 |
| | −3 to −2 | OFF | 3 |
| | −4 to −3 | OFF | 2 |
| | −5 to −4 | OFF | 1 |
| | −6 to −5 | OFF | 0.9 |
| | −7 to −6 | OFF | 0.8 |
| | −8 to −7 | OFF | 0.7 |
| | −9 to −8 | OFF | 0.6 |
| | −10 to −9 | OFF | 0.5 |
| | less than −10 | OFF | 0.4 |

From the forgoing, it is apparent that the present invention provides a variable indication to an operator allowing an easy determination of a level status, including the approximate degree of tilt up or tilt down of bucket 26 during operation. If an operator desires not to use the level indicator feature of the present invention, on-off switch 40 is simply turned off.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claim

What is claimed is:

1. A work machine, comprising:
a machine frame;
a loader including a loader frame coupled with said machine frame, a pair of booms pivotally carried by said loader frame, and a bucket pivotally carried at a forward end of said booms;
an electronic level indicator including a first indicator providing an indication of a relative angular orientation between said loader frame and at least one said boom, a second indicator providing an indication of a relative angular orientation between said bucket and at least one said boom, a visual indicator, and a controller coupled with each of said first indicator, said second indicator and said visual indicator, said controller receiving an input signal from each of said first indicator and said second indicator and actuating said visual indicator to indicate when said bucket is level.

2. The work machine of claim 1, wherein said controller also actuates said visual indicator to indicate when said bucket is tipped up and tipped down.

3. The work machine of claim 2, wherein said controller actuates said visual indicator to indicate an approximate degree that said bucket is tipped up and tipped down.

4. The work machine of claim 3, wherein said visual indicator includes a vertically arranged top light and bottom light, said top light only being energized when said bucket is tipped up, said bottom light only being energized when said bucket is tipped down, and each of said top light and said bottom light being energized when said bucket is level.

5. The work machine of claim 4, wherein when said bucket is tipped up, said top light is repetitively energized with a frequency corresponding to a degree to which said bucket is tipped up, and wherein when said bucket is tipped down, said bottom light is repetitively energized with a frequency corresponding to a degree to which said bucket is tipped down.

6. The work machine of claim 5, wherein said top light and said bottom light are respectively energized with a higher frequency as said bucket approaches level, and a lower frequency as said bucket is positioned further from level, each of said top light and said bottom light being continuously energized when said bucket is level.

7. The work machine of claim 1, wherein said first indicator comprises a sensor coupled between said loader frame and one said boom, and said second indicator comprises a sensor coupled between said bucket and at least one said boom.

8. The work machine of claim 1, wherein said level indicator includes an on-off switch.

9. A level indicator for a material bucket on a work machine, comprising:
a first indicator providing an indication of a relative angular orientation between a loader frame and at least one boom;
a second indicator providing an indication of a relative angular orientation between a bucket and at least one said boom;
a visual indicator; and
a controller coupled with each of said first indicator, said second indicator and said visual indicator, said controller receiving an input signal from each of said first indicator and said second indicator and actuating said visual indicator to indicate when said bucket is level.

10. The level indicator of claim 9, wherein said controller provides a variable indication using said visual indicator to indicate when bucket is level, tipped up and tipped down.

11. The level indicator of claim 10, wherein said controller provides a variable indication to indicate a degree to which said bucket is one of tipped up and tipped down.

12. The level indicator of claim 9, wherein said controller also actuates said visual indicator to indicate when said bucket is tipped up and tipped down.

13. The level indicator of claim 12, wherein said controller actuates said visual indicator to indicate an approximate degree that said bucket is tipped up and tipped down.

14. The level indicator of claim 13, wherein said visual indicator includes a vertically arranged top light and bottom light, said top light only being energized when said bucket is tipped up, said bottom light only being energized when said bucket is tipped down, and each of said top light and said bottom light being energized when said bucket is level.

15. The level indicator of claim 14, wherein said top light is repetitively energized with a frequency corresponding to a degree to which said bucket is tipped up, and said bottom light is repetitively energized with a frequency corresponding to a degree to which said bucket is tipped down.

16. The level indicator of claim 15, wherein said top light and said bottom light are respectively energized with a higher frequency as said bucket approaches level, and a lower frequency as said bucket is positioned further from level, each of said top light and said bottom light being continuously energized when said bucket is level.

17. The level indicator of claim 9, wherein said first indicator comprises a sensor coupled between said loader frame and one said boom, and said second indicator comprises a sensor coupled between said bucket and at least one said boom.

18. The level indicator of claim 1, wherein said level indicator includes an on-off switch.
